(19) United States
(12) Patent Application Publication
(10) Pub. No.: US 2002/0135614 A1
(43) Pub. Date: Sep. 26, 2002

(54) Updating user interfaces based upon user inputs

(75) Inventor: Steven M. Bennett, Hillsboro, OR (US)

Correspondence Address: Julie L. Reed, MARGER JOHNSON & McCOLLOM, P.C., 1030 S.W. Morrison Street, Portland, OR, 97205, US

(73) Assignee: Intel Corporation, Santa Clara, CA (US)

(21) Appl. No.: 09/815,439

(22) Filed: Mar. 22, 2001

(51) Int. Cl. G06F 3/00

(52) U.S. Cl. 345/745; 345/811

(57) ABSTRACT

A method of presenting catered information to a user. An item to be output to the user is identified and sub-items are retrieved from at least one storage. The system builds output from the sub-items and presents the output to the user. User interface activity is recorded in storage and used to modify the user interface.

### BACKGROUND

1. Field

This disclosure relates to user interfaces, more particularly to methods for adapting user interfaces with bandwidth limitations.

2. Background

The wealth of information available today complicates the design of user interfaces. Designers must allow users to receive information about the desired topics without providing too much information or the wrong level of detail. Information can be generally sorted by information type, such as e-mail, stock tickers, calendar, flight information, traffic information, weather, etc.

Each type of information may have several sub-items. For example, an e-mail message may have sub-items such as subject, sender, time sent, time received, message text, other recipients, and importance, just to name a few. For most information types and most user interfaces, it is impractical to deliver all of the sub-items for a given item simultaneously. It is also impractical to present a great number of items simultaneously.

These impracticalities arise from four fundamental limitations. First, the amount of time or space available to relay information to the user is limited. Second, the communication bandwidth to the user is limited. Third the communication latencies to the user are long. Fourth, the user's ability to understand and recall more than a few items in a short period of time is limited. The remainder of this disclosure refers to these limitations simply as “bandwidth limitations” though it must be understood that any or all of the above limitations may be included.

For some interfaces, such as a web browser on a high-speed network connection, the user's abilities are the limiting factor. For devices like cell phones, PDAs with wireless connections, pagers, voice interfaces, etc., the first three factors have the largest effect on the amount of information that can be presented. Regardless of the limiting factor affecting the presentation of information, a method for catering or tailoring the information presented would allow a more efficient and effective use of the limited communication channel.

### BRIEF DESCRIPTION OF THE DRAWINGS

The invention may be best understood by reading the disclosure with reference to the drawings, wherein:

FIG. 1 shows a block diagram of one embodiment of an adaptive user interface system, in accordance with the invention.

FIG. 2 shows a flow chart of one embodiment of a method for providing an adaptive user interface, in accordance with the invention.

### DETAILED DESCRIPTION OF THE EMBODIMENTS

Several examples of dynamic user interfaces exist. Without any intention of limiting the scope of the invention and only for ease of discussion, these examples typically fall into one of four different categories.

The first category includes those systems that require explicit user action to update the user interface. One example in this category is BeVocal. BeVocal supplies a voice portal service that includes some limited user-directed customization. For example, it allows a user to specify a group of stocks that are of interest and to get quotes for all of them using a single command. Additionally, the user can request quotes for an arbitrary stock. New stocks can be added to the user's portfolio after any stock quote is requested, but requires the user to explicitly request that the company be added.

Similarly, some web sites incorporate a ‘my portfolio’ idea and allow new stocks to be added to the site using a method similar to the BeVocal example above. Some search engines such as Lycos™, iWon™ and Yahoo!™ allow the user to designate those pages as their home page and customize them. However, these interfaces require explicit user designations for customization.

A second category is those user interfaces that are updated by simple history mechanisms. Examples of these include inbound and outbound histories on cell phones, where the last few outgoing and incoming numbers are stored, and history stored in web browsers through the address bar and the back button. Similarly, in many Microsoft Office® applications, the list of available pull-down menu items changes based upon items used in the past. However, these history mechanisms are relatively simple and do not use any kind of predictive methodologies based upon user preferences and contextual information, among others, to change the content presented in the user interface or the structure of the user interface.

A third category includes those user interfaces that use context to update the information presented. An example is found in web search engines such as Google and AltaVista. Results from these search engines typically show a URL and a hot link that says something like “Show me related sites.” The related sites are found by the search engine using simple term frequency inverse document frequency analysis (TFIDF) and an analysis of the domain of the site. These interfaces do not account for history or for user-specific preferences.

A fourth category includes those interfaces that use context and user information to change the user interface. Many projects are in work attempting to automate the process of browsing the web. They dynamically determine a set of possible pages that the user may want to go to next based upon a profile of the user, the page being viewed and a history of the user's browsing habits. An example of this type of interface is Let's Browse from the MIT Media Lab. The activity in the user interface that the system tracks is quite limited, clicking on the links. It tracks those inputs only indirectly by incorporating the term frequency inverse document frequency (TFIDF) profile of the visited page into the user's profiles.

Unlike the examples above, application of this invention results in dynamically and automatically catering the breadth and depth of information presented to the user based upon the user's interaction with the system, both present and previous, as well as user preferences and contextual information.

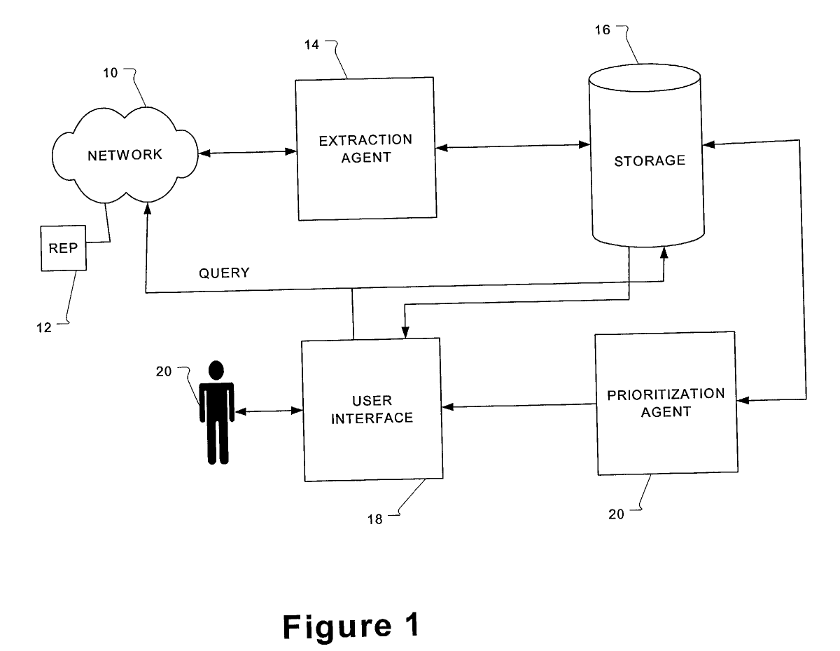

Referring to FIG. 1, a user 20 accesses information through a user interface 18. The user interface could be a visual interface on a personal digital assistant, a phone, including a cellular phone, a Web phone, a landline phone, a satellite phone, etc., a pager, a network appliance, or a personal computer as examples. Alternatively, the user interface may be a speech interface which the user accesses over the phone or through a multimedia personal computer, for example. The user interface may also be multimodal, where the input is in one mode, such as visual, audio or mechanical, and the output in another. The user interface 18 presents information to the user and allows the user to control the information presented by way of queries, designation of user preferences, etc.

When the user requests information, it is presented on the user interface 18 after being gathered by the system. The content initially comes from a repository of information 12, which may or may not be connected to the information system by a network 10. A current example would be the user accessing information from the resources over the Internet. There may be several repositories of information accessible through the network. The repository of information 12 may be a central server at a corporation, for example, that keeps a users calendar and e-mail, such as a Microsoft Exchange Server™.

An extraction agent 14 monitors the repository of information 12 for updated and new data and then fetches it to the storage 16. This is done by direction of the user, either through a direct and explicit direction, or from an analysis of the user's historical requests and a ‘smart’ agent that determines the user's interests from the past history and contextual information such as, for example, a calendar or travel itinerary.

A prioritization agent 20 examines the content and contextual information and determines what is of highest value to the user. This information is then presented to the user. Note that in communications with high bandwidth connections, prioritization is less critical. In the extreme, the user is just presented with all available information. When bandwidth is limited, either by the communications link or the size of the interface, the information presented must be tailored to the user as closely as possible.

The tailoring or catering of the information can be done in both breadth and depth. For purposes of this discussion, breadth of information will refer to the number of items presented and the depth of information will refer to the number of sub-items presented for each item. The prioritization agent makes the decisions as to the catering of the information based upon user preferences, user history, user queries, other user interface activity and other contextual information.

The user makes queries through the user interface. These requests may be sent over the network to the repository 12 or satisfied by information in the storage 16. For example, the user may be presented with an item regarding flight information and the user may request the arrival gate information. That information may have been stored in the storage and the prioritization agent did not present it to the user. In that case, the request is satisfied by the storage 16. If the information was not present in the repository, then the request would be relayed to the repository and the results sent to the storage. As will be discussed further, the query information can be stored to alter the user interface for presentation of flight information in the future. This would be an example of catering the depth of the information, since the number of items presented was not changed, but the number of sub-items for the flight item was changed. Examples of catering the breadth of information presented are given below.

The storage 16 could take many forms. It may be a database, a linked list, or other form of organized memory that holds information. It may be indexed, organized or otherwise searchable to allow the system to access the information being requested. It will also store information regarding user interface activity, although that may also be done in a separate storage.

The entire system could be ‘local’ in that the user interface, the storage and the repository could all reside on one device, such as those mentioned above. Additionally, the storage and repository may reside on the same device. In current implementations, however, the devices on which the user interfaces reside are typically constrained by form factor, memory and power consumption concerns. More than likely, current implementations will provide the user interface on the device, an intermediate device like a server to hold the storage and the agents, and a network connection for access to the repository. In time, however, the various parts of the system could migrate to the device. For example, the user interface, the agents and the storage could reside on the device and the information repository may be accessed across a network. However implemented, the system will cater the depth and/or the breadth of information to the user.

The difference between the breadth and the depth of the information as used in this discussion is shown by the following example. Assume a system presents three items to the user, A, B, and C. Each of these items has sub-items, A.1-A.5, B.1-B.6 and C.1-C.3. However, the system determines that is will only present the following in priority order, based upon the information type, previous usage patterns, user preferences and contextual information.

A: A.1, A.3, A.5

B: B.2, B.6, B.1

C: C.1.

The user then requests a further item, D. The next time the user interacts with the system, the user interface may present:

A: A.1,A.3,A.5

B: B.2, B.6, B.1

C: C.1

D: D.1, D.3, D.5.

This is an example of catering the breadth of information. Item D will be referred to as a user-specific item here.

The original list of items presented to the user may be adapted to show a different depth of information. In this case, the user may request a sub-item that was not delivered, such as A.2. Upon the next interaction with the system by the user, the user interface may present:

A: A.1, A.3, A.5, A.2

B: B.2,B.6,B.1

C: C.1.

This is an example of catering the depth of the information presented. If the item A.2 is included for all items that are of the same information type as A, it is referred to as an item-type specific sub-item. If it is included only for item A, it is called an item-specific sub-item.

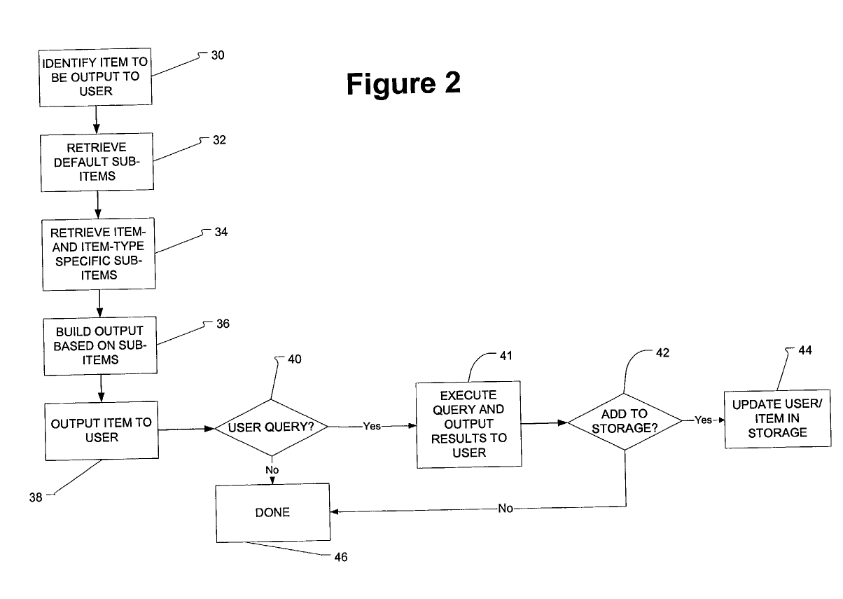

One embodiment of a method to cater information presented to a user is shown in FIG. 2. At 30, an item is identified for output to the user. The identified item may be a user-specific item or an item that the prioritization agent has marked for presentation. The default sub-items for this item are then retrieved at 32 and the item-specific and item-type specific sub-items are retrieved at 34. An output is built using the sub-items within the limitations of the user interface. A simple example may be that six sub-items were retrieved and only 3 can be presented for that particular item. The six sub-items retrieved would then be prioritized and the three top-priority items would be output.

The output is given to the user at 38. The processes 30 through 38 may be repeated for each item to be presented to the user, until all of the items are presented. If the user makes a further query about one of the items, or an item not presented, that information is retrieved and presented to the user at 41. At 42 a determination is made as to whether the results of the query should be added to the storage for retrieval when that item or other items of the same type are to be presented to the user again. The determination may again be decided upon by priority, timing and other contextual information.

Additionally, information regarding user interface activities other than queries may be placed in the storage for use by the prioritization agent and user interface. FIG. 1 is focused specifically on the activity surrounding queries regarding an item that the system has presented to the user, but this in no way limits the scope of the invention. The following examples illustrate this non-query user interface activity and its effect on the presentation of information in the future.

If the user indicates that he is not interested in hearing stock volume information for any stocks, the system may record this and change presentation of stock information accordingly. This is similar to the item-type specific sub-items discussed above, but differs in that the user may make this statement independent of the presentation of a stock item by the system. If the user interface allows the user to change the way that items are sorted, for example by clicking on a column heading in a visual interface, the system may record this activity and automatically present information sorted in a particular fashion. Again, this activity is independent of the items presented to the user. These examples illustrate how the invention uses non-query user interface activity to dynamically and automatically change the user interface.

If other items have moved up in importance due to recent changes in status or other information, the query may not be high enough priority to be added to the storage. Additionally, the request could have a time component that expires. For example, the user may have accessed the flight information for the arrival of a family member. Further, the user queried the system about the baggage claim location shortly after the time of the flight arrival. The system may not add that query to the storage because it is relevant only for the short period of time after arrival. If, however, the query were to be added to the storage, it would be added at 44. The addition may be associated with a specific item, or it may be associated with all items of a particular information type. The baggage claim location could be associated with that one flight, or the baggage claim location could be added to all items containing flight information.

As mentioned above, this method is particularly useful for systems with a limited bandwidth to the user. It allows the system to prioritize and present only high-priority information to the user, reducing the amount of time and network bandwidth required to present the information to the user. At the same time, it allows the user to interact with the system and make the system more accurate, without having to make explicit decisions about what gets presented. The limited bandwidth communication system could be a personal digital assistant, a cellular phone or other voice portal, including telephones or other voice communications, a pager, a personal computer or a networked appliance. These are only examples and not intended to limit application of the invention in any way.

For example, a voice activated user interface useful for users of cell phones could be the limited communications bandwidth system. A user desiring information would call into its service provider and the service provider would allow the user to access the information desired with voice commands. An interaction with the system may occur as follows:

[User dials in and logs in with a user id and password.]

User: First item.

System: Calendar entry: You have a meeting with Jenny at 11:15 AM in room C.

User: Next item.

System: ABC Corp is up 4 at 54.

User: Next item.

System: No further items.

User: How is XYZ doing?

System: XYZ is up 2 at 98.

User: Goodbye.

The system presented the user with two items that it has predicted to be of high importance. The user then requested another piece of information that the system did not predict to be of importance. In some instances, the system may remember it and automatically include it in the top priority items. In that case, the user interface would change for next interaction with the system:

[User dials in and logs in with a user id and password.]

User: First item.

System: Calendar entry: You have a meeting with Jenny at 11:15 AM in room C.

User: Next item.

System: ABC Corp is up 4 at 54.

User: Next item.

System: XYZ is up 2 at 98.

User: Next item.

System: That was the last item.

User: Goodbye.

The determination of whether or not the item regarding XYZ is included may be based on several things. It may be included unconditionally, only if a significant change has occurred with that item, if other items have not superseded the priority based on recent events, the number of times that stock price has been requested, among others. However the determination is made, the system will cater the breadth of the information requested. The item regarding XYZ is a user-specific item.

An example of catering the depth of the information requested is shown below. Prior to any queries from the user, the interaction may be as follows:

User: First item.

System: Calendar entry: You have a meeting with Jenny at 11:15 AM in room C.

User: Is lunch being served?

System: Yes, lunch will be served.

User: Next item.

System: ABC Corp is up 4 at 54.

User: Next item.

System: No further items.

User: Goodbye.

The system presented the two items it had decided were the most important, and on the first had presented only three sub-items, the person with whom the user was meeting, the time and the place. The user then requests another sub-item, whether lunch was being served. During the user's next interaction with the system, the presentation would be something like:

User: First item.

System: Calendar entry: You have a meeting with Jenny at 11:15 AM in room C.

Lunch is being served.

User: Next item.

System: ABC Corp is up 4 at 54.

User: Next item.

System: No further items.

User: Goodbye.

As mentioned above, the system may only add that sub-item for that particular meeting, or for all meetings falling around lunchtime, for example. If the sub-item regarding lunch is added for only that particular meeting, it is an item-specific sub-item. If it is added for all meetings, it is an item-type specific sub-item.

The above examples demonstrate methods for catering both the breadth and depth of information presented to the user through a user interface. However, the examples above were only for adding information. This could result in a user receiving too much information within the confines of the limited communication channel. For example, the voice interface above may result in the user receiving more items over the phone than the user can remember. Some mechanism must exist to allow removal of the item or sub-items.

As mentioned above, many of the items may ‘time out.’ That is, the time for which those items are pertinent, such as the meeting example or the flight information example, will expire and the items will be removed. For purposes of removal, ‘item’ will refer to both items and sub-items. Alternatively, the information can be removed after a fixed time or a fixed number of interactions. The system could allow the user to designate levels or thresholds above or below which the information is deemed interesting and only present the information when it is interesting. If the stock of XYZ goes up or down more than 5 points, it could be deemed interesting and reported to the user. If the stock goes up or down less than 5 points, the information is not interesting and not reported. Alternatively, the user could explicitly remove the items. For example, when the system says, “You have a meeting at 11:15 . . .” the user could just say “Remove item,” and the item would be deleted.

The implementation of the methods and apparatus of the invention may vary widely. The user interface could be part of an entirely new system, or an upgrade to an existing system. For example, this invention is a useful addition to the voice user interfaces provided by voice portals such as AOL and BeVocal and the visual interfaces provided by the mobile device portals of AOL and Palm. Both of these systems already track a variety of information about users and provide user interfaces with limited bandwidth. Adding the necessary pieces may involve some new equipment and software. In any case, the methods of the invention may be executed from instructions contained on an article, such as a diskette, an executable file or a CD-ROM. The instructions, when executed, perform the steps of the invention.

These examples are intended only as such and are not intended to limit the scope of the invention. There has been described to this point a particular embodiment for a method and apparatus for updating user interfaces based upon user inputs, it is not intended that such specific references be considered as limitations upon the scope of this invention except in-so-far as set forth in the following claims.

What is claimed is:

1. A method of presenting catered information to a user, the method comprising:
a) identifying an item to be output to the user;
b) retrieving sub-items from storage;
c) building output from the sub-items;
d) presenting the output to the user; and
e) recording any user interface activity in storage.

2. The method of claim 1, wherein the storage further comprises a database.

3. The method of claim 1, wherein the storage further comprises an in-memory data structure.

4. The method of claim 1, wherein recording user interface activity further comprises:
a) determining if the activity should change the default presentation for future information requests; and
b) if the activity should change the default presentation for future information requests, adding this information to storage as one of a user-specific item, an item-specific sub-item, anitem-type specific sub-item or a user preference.

5. The method of claim 1, wherein the method further comprises removing items added as a result of user interface activity.

6. The method of claim 5, wherein the removal of items added as a result of user interface activity occurs when directed by the user

7. The method of claim 5, wherein the removal of items added as a result of user interface activity occurs after a certain number of presentations to the user.

8. The method of claim 5, wherein the removal of items added as a result of user interface activity occurs after a fixed time.

9. The method of claim 5, wherein the removal of items added as a result of user interface activity occurs when the item is no longer deemed uninteresting.

10. The method of claim 1, wherein the sub-items include default sub-items for the item to be output to the user.

11. The method of claim 1, wherein the sub-items include user-specific sub-items derived from previous user interface activity.

12. The method of claim 1, wherein the sub-items include item-specific sub-items derived from previous user interface activity.

13. The method of claim 1, wherein the sub-items include item-type specific sub-items derived from previous user interface activity.

14. The method of claim 1, wherein presenting output to the user is accomplished using one of the group comprised of: a personal computer, a personal digital assistant, a phone, a pager, and a network appliance.

15. An information presentation system, comprising:
a) a repository of information;
b) an extraction agent operable to monitor and fetch information from the repository as directed by a user;
c) a storage operable to store information and user priorities;
d) a prioritization agent operable to determine a priority of presentation of the information; and
e) a user interface operable to present at least part of the information to the user.

16. The system of claim 15, wherein the repository of information resides on a different device than the storage.

17. The system of claim 15, wherein the repository of information resides on the same device as the storage.

18. The system of claim 15, wherein the storage resides on the same device as the user interface.

19. The system of claim 15, wherein the storage resides on a different device than the user interface.

20. The system of claim 15, wherein the user interface is presented by one of the group comprised of: a phone, a personal digital assistant, a pager, a personal computer and a network appliance.

21. The system of claim 15, wherein the user interface is an audio interface.

22. The system of claim 15, wherein the user interface is a visual interface.

23. The system of claim 15, wherein the user interface is multimodal.

24. An article including instructions that, when executed by a machine, cause it to:
a) identify an item to be output to the user;
b) retrieve sub-items;
c) build of output from the sub-items;
d) present the output to the user; and
e) record any query about the output in the storage.

25. The article of claim 24, wherein the instructions, when executed by a machine, further cause it to:
a) determine if the query should be included as a default for future information requests; and
b) if the query should be included as a default, add a specific field to the storage.

26. The article of claim 24, wherein the instructions, when executed by a machine, further cause it to remove items when directed by the user.

27. The article of claim 26, wherein the removal of items added as a result of user interface activity occurs when directed by the user

28. The article of claim 26, wherein the removal of items added as a result of user interface activity occurs after a certain number of presentations to the user.

29. The article of claim 26, wherein the removal of items added as a result of user interface activity occurs after a fixed time.

30. The article of claim 26, wherein the removal of items added as a result of user interface activity occurs when the item is no longer deemed uninteresting.
